(19) United States
(12) Patent Application Publication
(10) Pub. No.: US 2013/0085590 A1
(43) Pub. Date: Apr. 4, 2013

(54) SYNTHETIC BONE MODEL AND METHOD FOR PROVIDING SAME

(71) Applicants: Jason A. Bryan, Avon Lake, OH (US); Ryan S. Klatte, Fairview Park, OH (US); Peter D. O'Neill, Shaker Heights, OH (US)

(72) Inventors: Jason A. Bryan, Avon Lake, OH (US); Ryan S. Klatte, Fairview Park, OH (US); Peter D. O'Neill, Shaker Heights, OH (US)

(21) Appl. No.: 13/629,653

(22) Filed: Sep. 28, 2012

Related U.S. Application Data
(60) Provisional application No. 61/542,605, filed on Oct. 3, 2011.

(51) Int. Cl. G06F 17/50

(52) U.S. Cl. 700/98

(57) ABSTRACT

A method for providing a synthetic bone model of a subject bone includes providing a file with data representing a three-dimensional subject bone. Manufacturing instructions are generated based upon at least a portion of the data. The manufacturing instructions are transferred to a manufacturing device. A thin-walled outer shell of the synthetic bone model is created directly from the manufacturing instructions using the manufacturing device. The outer shell defines an inner cavity. A filler material is placed within at least a portion of the inner cavity. A synthetic bone model is also disclosed.

### RELATED APPLICATION

This application claims priority from U.S. Provisional Application No. 61/542,605, filed 3 Oct. 2011, the subject matter of which is incorporated herein by reference in its entirety.

### TECHNICAL FIELD

The present invention relates to a modeling method and system and, more particularly, to a synthetic bone model and a method for providing same.

### BACKGROUND OF THE INVENTION

It is common in the surgical setting to machine or modify patient tissue to permit use of internal screws for fixation of fractures, to implant artificial joints, to fix intramedullary implants, for arthroplasty purposes, and to facilitate various other surgical procedures. These surgical procedures involve precise machining of sensitive tissues. Particularly when the surgical procedure is an unusual or complex one, or the patient's tissue structure includes abnormalities (whether congenital or acquired), the surgeon may wish to rehearse or refine the surgical procedure in advance on a physical model of the patient's tissue structure to anticipate interoperative difficulties or to test different solutions for the patient's problem. The surgeon may also or instead wish to have a physical model of the patient's tissue structure for consultation, experimental, or any other purposes (before, during, or after the surgical procedure), even if no physical modifications are made to the model. Furthermore, physical models of general (non-patient-specific) patient tissues may be useful in teaching, training, rehearsal, patient education, or many other applications in the medical field.

Currently, “Sawbones” physical patient tissue models are available from Pacific Research Laboratories, Inc. of. Vashon, Wash. These models can be generic or customized to a particular patient tissue. However, “Sawbones” models, particularly custom versions, can be relatively expensive and/or time-consuming to obtain.

### SUMMARY OF THE INVENTION

In an embodiment of the present invention, a method for providing a synthetic bone model of a subject bone is disclosed. A file with data representing a three-dimensional subject bone is provided. Manufacturing instructions are generated based upon at least a portion of the data. The manufacturing instructions are transferred to a manufacturing device. A thin-walled outer shell of the synthetic bone model is created directly from the manufacturing instructions using the manufacturing device. The outer shell defines an inner cavity. A filler material is placed within at least a portion of the inner cavity.

In an embodiment of the present invention, a synthetic bone model is disclosed. A thin-walled outer shell is formed by a manufacturing device directly from manufacturing instructions. The manufacturing instructions are based upon data digitally representing at least a portion of a three-dimensional subject bone. The outer shell defines an inner cavity. A filler material is located within at least a portion of the inner cavity. The outer shell is made from a shell material that is different from the filler material.

In an embodiment of the present invention, a non-transitory computer readable storage medium storing computer executable instructions is disclosed. The computer executable instructions, when executed on a computer, form a method comprising providing a file with data representing a three-dimensional subject bone. A contour of the subject bone is extracted. Manufacturing instructions based upon at least a portion of the extracted contour are generated. The manufacturing instructions are provided to an output interface in a user-comprehensible form. The manufacturing instructions are transferred to a manufacturing device. A thin-walled outer shell of the synthetic bone model is created directly from the manufacturing instructions using the manufacturing device. The outer shell is made of a shell material and defines an inner cavity. A filler material, different from the shell material, is placed within at least a portion of the inner cavity.

### BRIEF DESCRIPTION OF THE DRAWINGS

For a better understanding of the invention, reference may be made to the accompanying drawings, in which:

FIGS. 1A-1C are various perspective views of one embodiment of the present invention;

FIG. 2 is a flow chart illustrating an example process for creating the embodiment of FIGS. 1A-1C; and

FIG. 3 is a schematic view of a computer system that can be employed to implement systems and methods described herein, such as based on computer executable instructions running on the computer system.

### DESCRIPTION OF EMBODIMENTS

An example subject bone is shown and described herein at least as a scapula or portion thereof, but the subject bone could be any desired types such as, but not limited to, hip joints, shoulder joints, knee joints, ankle joints, phalangeal joints, metatarsal joints, spinal structures, long bones (e.g., fracture sites), or any other suitable patient tissue use environment for the present invention.

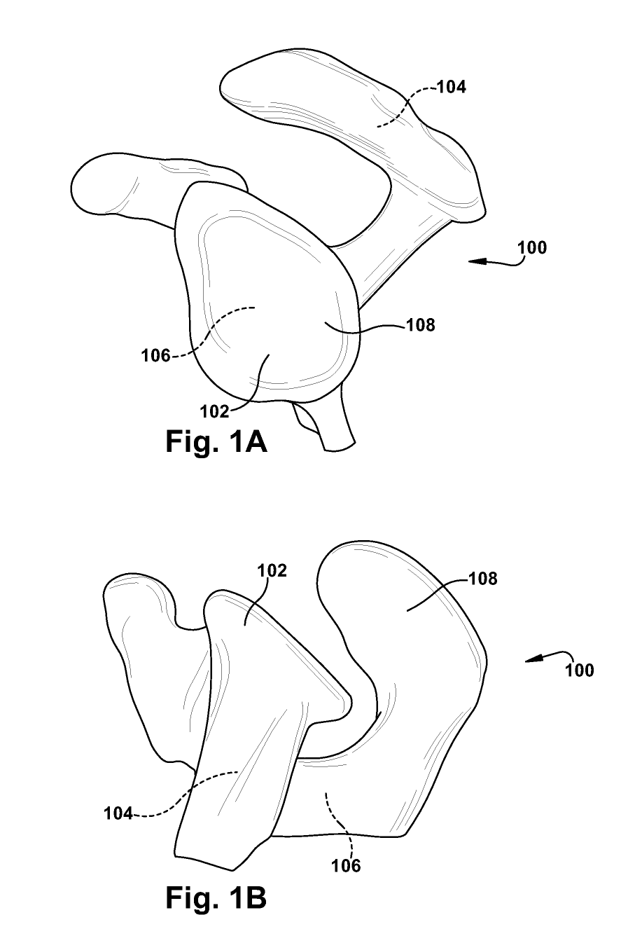

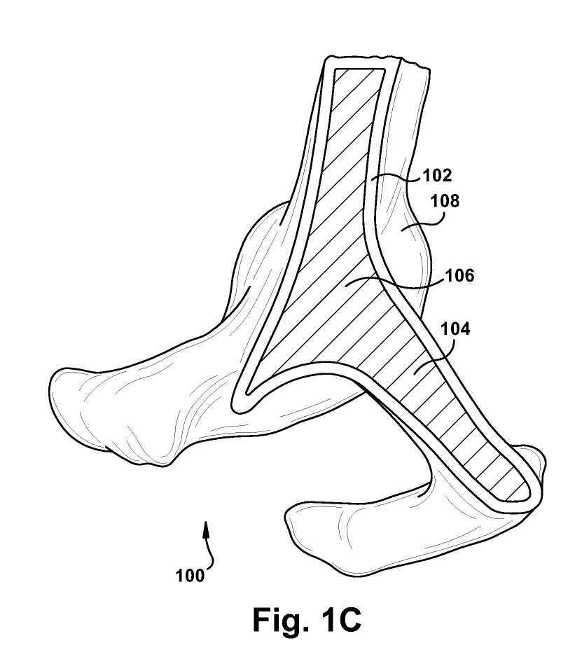

In accordance with the present invention, FIGS. 1A-1C depict a synthetic bone model 100. The synthetic bone model 100 includes a thin-walled outer shell 102, which is formed by a manufacturing device directly from manufacturing instructions. The manufacturing device implementing the manufacturing instructions could be a rapid prototyping device, which is a type of machine that can take manufacturing instructions from a computer and responsively create a structure from raw material(s). A rapid prototyping device is a different type of construction technology than, for example, a molding process wherein a mold is made in any desired fashion, filled with a raw material, and then the mold is removed to leave the raw material as the created structure. With a rapid prototyping device (sometimes generically called a “three-dimensional printer”), there commonly is substantially no “negative” or other extraneous structure created in the process of creating the target structure and therefore there is less waste material using rapid prototyping than using molding or many other conventional manufacturing processes. Suitable rapid prototyping devices/processes for use with the present invention include, but are not limited to, additive manufacturing devices/processes (e.g., selective laser sintering [SLS], fused deposition modeling [FDM], direct metal laser sintering [DMLS], stereolithography [SLA], cladding, electron beam melting, electron beam direct manufacturing, aerosol jetting, ink jetting, semi-solid freeform fabrication, digital light processing, 2-photon photopolymerization, laminated object manufacturing [LOM], 3-dimensional printing [3DP], and the like) and subtractive manufacturing devices/processes (e.g., computer numerical control machining [CNC], electrical discharge machining, electrochemical machining, electron beam machining, photochemical machining, ultrasonic machining, contour milling from a suitable material, and the like).

The manufacturing instructions may be based upon data digitally representing at least a portion of a three-dimensional subject bone, shown here as a scapula. The term “digital representation” is used herein to indicate a replica or copy of a physical item, at any relative scale. The digital representation of the subject bone may be a total or partial representation of a subject patient tissue, and may be created in any suitable manner. For example, and as presumed in the below description, the digital representation may be based upon computer tomography (“CT”) data imported into a computer aided drafting (“CAD”) system. Additionally or alternatively, the digital representation may be based upon digital or analog radiography, magnetic resonance imaging, or any other suitable imaging means. The digital representation will generally be displayed for the user to review and manipulate preoperatively, such as through the use of a computer or other graphical workstation interface.

The outer shell 102 defines an inner cavity 104. As can be seen in FIG. 1C, a filler material 106 is located within a portion of the inner cavity 104. The outer shell 102 may be made from a shell material 108 that is different from the filler material 106. For example, the shell material 108 may have a first density and the filler material 106 may have a second density; optionally, the second density is less than the first density. The shell material 108 may be any suitable rapid prototyping material configured for use with a rapid prototyping machine, such as, but not limited to, cold-cure resin, epoxy resin, other resins, 70% inorganic polymer, polyurethanes, urethanes, other polymers, waxes, modeling and tooling boards, clays, elastomers, pastes, plasters, cements, plastics, metals, candy, papier-mâché, and the like. The filler material 106 may be any suitable material which can be placed into at least a portion of the inner cavity 104 and maintained there, either through its own properties (e.g., drying or solidifying in place) or through the use of a barrier (not shown) substantially preventing egress of the filler material from the inner cavity. Suitable filler materials 106 include, but are not limited to, expandable urethane foam, expanded polystyrene foam, other foams, water, other fluids, and the like. Optionally, the filler material 106 could be substantially solid and formed or machined to fit within the desired portion of the inner cavity 104, but it is contemplated that, for most applications of the present invention, the filler material 106 will be selected for supply into the inner cavity 104 (flowing through possibly-labyrinthine inner passages) to substantially fill at least a portion of the inner cavity, and then to harden or cure in place and thereby remain within the inner cavity.

Optionally, the outer shell 102 could be removed, leaving the filler material 106 in a “molded” format for the user. In this case, the outer shell 102 could be designed as a “mold” and may be in a modified format that does not exactly replicate the three-dimensional subject bone; instead, the manufacturing instructions could be configured to shape the filler material 106 into the desired final structure. However, leaving the outer shell 102 intact as a portion of the final synthetic bone model 100 is contemplated for most applications of the present invention.

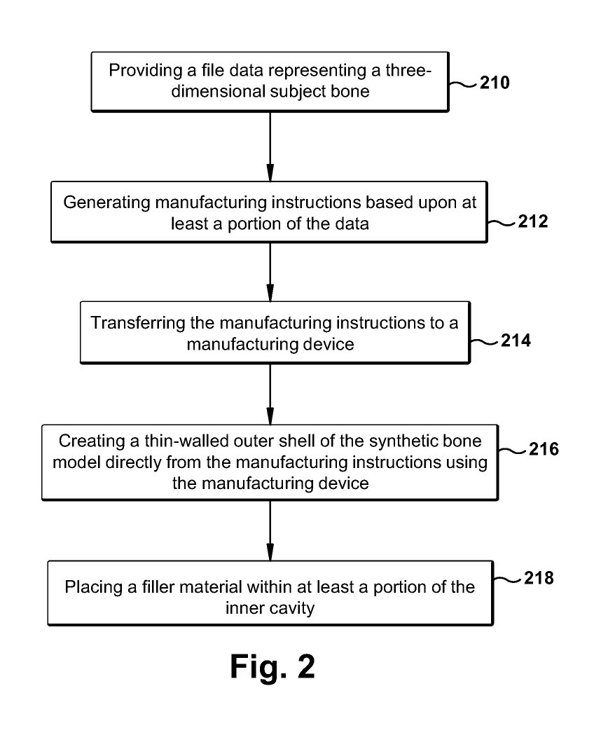

The flowchart of FIG. 2 represents a series of steps which may be used to create the synthetic bone model 100 of FIGS. 1A-1C. In first action block 210, a file with data representing a three-dimensional subject bone is provided. As previously mentioned, this file could be an image file. It is anticipated that some type of image processing may be desired to get the image file into a form which represents a three-dimensional subject bone. For example, undesirable artifacts of the scanning process (e.g., “shadows” due to the presence of metal on/in the patient tissue, “blurred” edges due to similar tissue densities near boundaries of internal patient tissue components, or the like) might be removed during generation of the data and/or later in the process described in FIG. 2.

In second action block 212, manufacturing instructions are generated based upon at least a portion of the data. These manufacturing instructions may be generated in any suitable manner and may be based upon any automatic or manual criteria or rules as desired for a particular combination of the input data, the manufacturing device, the manufacturing process, the desired synthetic bone model 100 to be produced, or any other factors, singly or in combination. For example, a computer-aided drafting (“CAD”) program may take in the data and responsively generate an STL file (a stereolithography instruction format file) for sending to a rapid prototyping machine. The manufacturing instructions may be generated, for example, by a process including the step of extracting an outer boundary or contour of the subject bone and projecting the outer contour inward by a desired thickness of the outer shell 102, then generating the manufacturing instructions based upon at least a portion of the extracted and/or projected outer contour. The desired thickness of the outer shell 102 may be of any desired size. For example, the outer shell 102 may have a thickness of between about 0.5 and 5 millimeters, more particularly about 2 millimeters, for certain applications of the present invention. The thickness of the outer shell 102 need not be constant, but could vary from place to place within the body of the outer shell. For example, it may be desirable for a particular protrusion of the outer shell to be solid, with no inner cavity 104 located therein—an example situation in which this may be desirable is if the user intends to alter or machine that area of the finished synthetic bone model 100 and wishes to have a substantially homogenous volume of shell material 108 to manipulate. It is contemplated that one of ordinary skill in the art will be able to specify a suitable outer shell 102 structure for a particular application of the present invention.

Optionally, the manufacturing instructions may be provided to an output interface in a user-comprehensible form. In other words, the manufacturing instructions could be used in combination with a printer, monitor, or any other suitable device to display anticipated properties (e.g., size, shape, color, or any other user-perceptible property) of the outer shell 102 of the synthetic bone model 100 to a user in a visual, numerical, tactile, or any other format. For example, the user may be presented with a three-dimensional (perspective) view on a monitor of the anticipated final appearance of the outer shell 102.

The patient's name, identification number, surgeon's name, and/or any other desired identifier may be molded into, printed on, attached to, or otherwise associated with the synthetic bone model 100 in a legible manner, either as a part of the manufacturing instructions or after the synthetic bone model has been created.

Third action block 214 includes the transfer of the manufacturing instructions to a manufacturing device (not shown). This manufacturing device could be any desired type, such as, but not limited to, those described above. One of ordinary skill in the art can readily choose a manufacturing device suitable for a particular application of the present invention. The manufacturing device could be directly linked to a source of manufacturing instructions, the manufacturing instructions could be finalized and provided to a manufacturing device through an indirect link (e.g., an Internet connection), the manufacturing instructions could be saved for later use, or any other method, system, order, or timing of provision of the manufacturing instructions to the manufacturing device could occur.

Once the manufacturing instructions have been transferred to a suitable manufacturing device, fourth action block 216 provides that the thin-walled outer shell 102 of the synthetic bone model 100, defining the inner cavity 104, is created directly from the manufacturing instructions using the manufacturing device. The term “created directly” is used herein to indicate that substantially no intermediate steps, structures, or processes occur during the process of receipt of the manufacturing instructions by the manufacturing device, authorization of the manufacturing device to begin producing the outer shell 102, performance of any necessary internal processing for the manufacturing device to recognize and implement the manufacturing instructions, and creation of the outer shell. For example, a “direct creation” does not include the use of a manufacturing device to create a mold, from which the outer shell 102 is molded. It is anticipated that the raw material used by the manufacturing device is the same shell material 108 (or is processed by the manufacturing device into the shell material) from which the outer shell 102 will be formed. It is anticipated that some type of support structure might be included in the outer shell 102 by the manufacturing device or that the structure of the outer shell may include some other type of artifact(s) of the manufacturing process when the outer shell is freshly created by the manufacturing device. Therefore, the user may choose to perform some post-creation “cleanup” or processing work, including a hardening or curing process, to create a final outer shell 102. The type of post-creation processing work needed or desired may depend upon the type of manufacturing process used.

In fifth action block 218, and once the outer shell 102 has finished with any desired post-creation processing, the filler material 106 is placed within at least a portion of the inner cavity 104. This placement may occur in any suitable manner and at any desired time after creation of the outer shell 102. For example, when the filler material 106 is an aerosol foam, a nozzle may be placed near and/or inside the outer shell 102 to dispense the filler material in a desired manner. The filler material 106 may be different from the shell material 108 for certain use environments of the present invention. One of ordinary skill in the art will be able to create a suitable arrangement of filler material 106 inside the outer shell 102 to create a desired synthetic bone model 100 for a particular application of the present invention. The filler material 106 may be placed within the outer shell 102 at any desired time, including before, during, or after creation of the outer shell. For example, the manufacturing device could be an additive manufacturing device that simultaneously creates the outer shell 102 and places the filler material 106 within at least a portion of the outer shell.

Optionally, the filler material 106 may be subject to some post-filling processing. For example, excess filler material 106 protruding from the outer shell 102 might be removed, the outer shell 102 and/or the filler material 106 may be subject to a hardening or curing process, or any other post-filling processing may be carried out as desired.

Once the filler material 106 has been placed into the outer shell 102 and any desired processing of either has been accomplished, the synthetic bone model 100 may be considered complete and may be used for reference, practice, or any other purpose as desired.

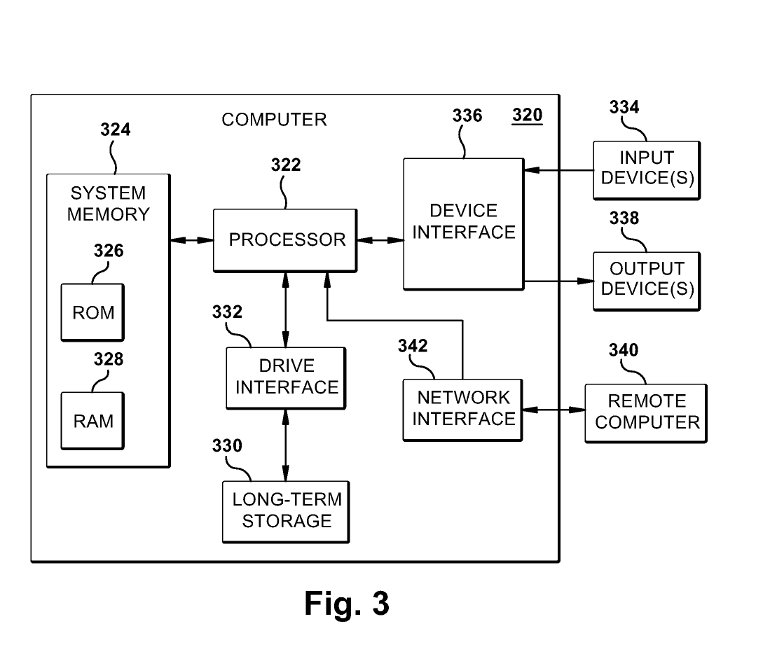

FIG. 3 illustrates a computer system 320 that can be employed to implement systems and methods described herein, such as those based on computer executable instructions running on the computer system. The user may be permitted to preoperatively simulate the planned surgical procedure using the computer system 320 as desired. The computer system 320 can be implemented on one or more general purpose networked computer systems, embedded computer systems, routers, switches, server devices, client devices, various intermediate devices/nodes and/or stand alone computer systems. Additionally, the computer system 320 can be implemented as part of the computer-aided engineering (CAE) tool running computer executable instructions to perform a method as described herein.

The computer system 320 includes a processor 322 and a system memory 324. Dual microprocessors and other multi-processor architectures can also be utilized as the processor 322. The processor 322 and system memory 324 can be coupled by any of several types of bus structures, including a memory bus or memory controller, a peripheral bus, and a local bus using any of a variety of bus architectures. The system memory 324 includes read only memory (ROM) 326 and random access memory (RAM) 328, which can both be considered computer-readable storage media. A basic input/output system (BIOS) can reside in the ROM 326, generally containing the basic routines that help to transfer information between elements within the computer system 320, such as a reset or power-up.

The computer system 320 can include one or more types of long-term data storage 330 or other computer-readable storage media, including a hard disk drive, a magnetic disk drive, (e.g., to read from or write to a removable disk), and an optical disk drive, (e.g., for reading a CD-ROM or DVD disk or to read from or write to other optical media). The long-term data storage 330 can be connected to the processor 322 by a drive interface 332. The long-term data storage 330 components provide nonvolatile storage of data, data structures, and computer-executable instructions for the computer system 320. A number of program modules may also be stored in one or more of the drives as well as in the RAM 328, including an operating system, one or more application programs, other program modules, and program data.

A user may enter commands and information into the computer system 320 through one or more input devices 334, such as a keyboard or a pointing device (e.g., a mouse). These and other input devices are often connected to the processor 322 through a device interface 336. For example, the input devices 334 can be connected to the system bus by one or more of a parallel port, a serial port, or a universal serial bus (USB). One or more output device(s) 338, such as a visual display device or printer, can also be connected to the processor 322 via the device interface 336.

The computer system 320 may operate in a networked environment using logical connections (e.g., a local area network (LAN) or wide area network (WAN) to one or more remote computers 340. A given remote computer 340 may be a workstation, a computer system, a router, a peer device or other common network node, and typically includes many or all of the elements described relative to the computer system 320. The computer system 320 can communicate with the remote computers 340 via a network interface 342, such as a wired or wireless network interface card or modem. In a networked environment, application programs and program data depicted relative to the computer system 320, or portions thereof, may be stored in memory associated with the remote computers 340, which can also be considered a computer-readable storage medium.

While aspects of the present invention have been particularly shown and described with reference to the preferred embodiment above, it will be understood by those of ordinary skill in the art that various additional embodiments may be contemplated without departing from the spirit and scope of the present invention. For example, the specific methods described above for using the described system are merely illustrative; one of ordinary skill in the art could readily determine any number of tools, sequences of steps, or other means/options for virtually or actually placing the above-described apparatus, or components thereof, into positions substantially similar to those shown and described herein. Any of the described structures and components could be integrally formed as a single piece or made up of separate sub-components, with either of these formations involving any suitable stock or bespoke components and/or any suitable material or combinations of materials. Though certain components described herein are shown as having specific geometric shapes, all structures of the present invention may have any suitable shapes, sizes, configurations, relative relationships, cross-sectional areas, or any other physical characteristics as desirable for a particular application of the present invention. Any structures or features described with reference to one embodiment or configuration of the present invention could be provided, singly or in combination with other structures or features, to any other embodiment or configuration, as it would be impractical to describe each of the embodiments and configurations discussed herein as having all of the options discussed with respect to all of the other embodiments and configurations. Any of the components described herein could have a surface treatment (e.g., texturization, notching, etc.), material choice, and/or other characteristic. The system is described herein as being used to plan and/or simulate a surgical procedure of implanting one or more prosthetic structures into a patient's body, but also or instead could be used to plan and/or simulate any surgical procedure, regardless of whether a non-native component is left in the patient's body after the procedure. A device or method incorporating any of these features should be understood to fall under the scope of the present invention as determined based upon the claims below and any equivalents thereof.

Other aspects, objects, and advantages of the present invention can be obtained from a study of the drawings, the disclosure, and the appended claims.

Having described the invention, we claim:

1. A method for providing a synthetic bone model of a subject bone, the method comprising the steps of:
providing a file with data representing a three-dimensional subject bone;
generating manufacturing instructions based upon at least a portion of the data;
transferring the manufacturing instructions to a manufacturing device;
creating a thin-walled outer shell of the synthetic bone model directly from the manufacturing instructions using the manufacturing device, wherein the outer shell defines an inner cavity; and
placing a filler material within at least a portion of the inner cavity.

2. The method of claim 1, wherein the subject bone template is an image file.

3. The method of claim 1, wherein the step of generating manufacturing instructions based upon at least a portion of the data includes the steps of:
extracting an outer contour of the subject bone; and
projecting the outer contour inward by a desired thickness of the outer shell.

4. The method of claim 1, wherein the outer shell is made from a shell material having a first density and the filler material has a second density.

5. The method of claim 4, wherein the second density is less than the first density.

6. The method of claim 1, wherein the outer shell is made from a shell material chosen from the group comprising cold-cure resin, epoxy resin, other resins, 70% inorganic polymer, polyurethanes, urethanes, other polymers, waxes, modeling and tooling boards, clays, elastomers, pastes, plasters, cements, plastics, metals, candy, and papier-mâché.

7. The method of claim 1, wherein the filler material is chosen from the group comprising expandable urethane foam, expanded polystyrene foam, other foams, water, and other fluids.

8. The method of claim 1, wherein the manufacturing device is a rapid prototyping device.

9. The method of claim 1, wherein the manufacturing device is at least one of an additive manufacturing device and a subtractive manufacturing device,

10. A synthetic bone model, comprising:
a thin-walled outer shell, formed by a manufacturing device directly from manufacturing instructions, the manufacturing instructions being based upon data digitally representing at least a portion of a three-dimensional subject bone, the outer shell defining an inner cavity; and
a filler material located within at least a portion of the inner cavity;
wherein the outer shell is made from a shell material that is different from the filler material.

11. The synthetic bone model of claim 10, wherein the shell material has a first density and the filler material has a second density.

12. The synthetic bone model of claim 11, wherein the second density is less than the first density.

13. The synthetic bone model of claim 10, wherein the shell material is chosen from the group comprising cold-cure resin, epoxy resin, other resins, 70% inorganic polymer, polyurethanes, urethanes, other polymers, waxes, modeling and tooling boards, clays, elastomers, pastes, plasters, cements, plastics, metals, candy, and papier-mâché.

14. The synthetic bone model of claim 10, wherein the filler material is chosen from the group comprising expandable urethane foam, expanded polystyrene foam, other foams, water, and other fluids.

15. The synthetic bone model of claim 10, wherein the manufacturing instructions are implemented by a rapid prototyping device.

16. The synthetic bone model of claim 10, wherein the manufacturing instructions are implemented by at least one of an additive manufacturing device and a subtractive manufacturing device.

17. A non-transitory computer readable storage medium storing computer executable instructions which when executed on a computer form a method comprising:
providing a file with data representing a three-dimensional subject bone;
extracting a contour of the subject bone;
generating manufacturing instructions based upon at least a portion of the extracted contour;
providing the manufacturing instructions to an output interface in a user-comprehensible form;
transferring the manufacturing instructions to a manufacturing device;
creating a thin-walled outer shell of the synthetic bone model directly from the manufacturing instructions using the manufacturing device, the outer shell being made of a shell material and defining an inner cavity; and
placing a filler material, different from the shell material, within at least a portion of the inner cavity.

18. The computer readable storage medium of claim 17, wherein the shell material has a first density and the filler material has a second density.

19. The computer readable storage medium of claim 17, wherein the second density is less than the first density.

20. The computer readable storage medium of claim 17, wherein the step of extracting a contour of the subject bone includes the steps of:
identifying an outer boundary of the subject bone; and
projecting the outer boundary inward by a desired thickness of the outer shell.
